(19) United States
(12) Patent Application Publication
(10) Pub. No.: US 2026/0157926 A1
(43) Pub. Date: Jun. 11, 2026

(54) PHYSIOLOGICAL IMPLEMENTS UTILIZING MAGNETS AND TERAHERTZ MATERIAL

(71) Applicant: Spence Spencer, Scottsdale, AZ (US)

(72) Inventor: Spence Spencer, Scottsdale, AZ (US)

(21) Appl. No.: 19/430,957

(22) Filed: Dec. 23, 2025

Related U.S. Application Data
(63) Continuation-in-part of application No. PCT/US24/24151, filed on Apr. 11, 2024.
(60) Provisional application No. 63/632,036, filed on Apr. 10, 2024.
(60) Provisional application No. 63/735,868, filed on Dec. 18, 2024.

(51) Int. Cl. A61H 23/02; A61H 23/00

(52) U.S. Cl. CPC A61H 23/02; A61H 23/006

(57) ABSTRACT

A physiological implement includes a terahertz material, a material that emits terahertz radiation in the frequency range of about 0.1-10 THz. The physiological implement may be a massage device and the massage device may be configured to vibrate, or a compression sleeve configured to extend around a limb of a person, a therapeutic composition for application to the skin of a person, a lens that is configured to extend over a light emitting device or laser, an air moving device, such as a hair dryer, a patch for application to a person's body, a sexual implement, an electronic device cover, a sleeping fabric or bag, a garment and the like.

### CROSS REFERENCE TO RELATED APPLICATIONS

This application is a continuation in part of international patent application No. PCT/US2025/024151, having an international filing date of Apr. 10, 2025, which claims the benefit of priority to U.S. provisional patent application No. 63/632,036, filed on Apr. 10, 2024, U.S. provisional patent application No. 63/688,817, filed on Aug. 29, 2024 and to U.S. provisional patent application No. 63/735,868, filed on Dec. 18, 2024; the entirety of each priority application is hereby incorporated by reference herein.

### BACKGROUND OF THE INVENTION

### Field of the Invention

The invention relates terahertz material incorporated into physiological implements and the method of using.

### Background

Physiological conditions particularly those related to muscular skeletal system can be complex and difficult to treat. There are often a wide number of interactions between muscle, tendons, ligaments, and the like, that can result in discomfort, pain, lack of mobility and reduced strength. Treating a particular system may require treatment via a plurality of techniques and apparatus to fully address the issue or issues.

### SUMMARY OF THE INVENTION

The invention is directed to terahertz material, and applications for treatment of

physiological conditions. Terahertz (THz) radiation is in the frequency range of about 0.1-10 THz (3 mm to 30 μm) and is between microwave and far infrared spectral regions.

Terahertz radiation can penetrate certain organic materials such as skin, plastics, textile and paper. Terahertz radiation has a relatively low photon energy, and therefore does not produce the damaging effects of other ionizing radiation, such as X-rays. Terahertz radiation cannot, however, penetrate metal. Certain materials may be made to emit terahertz radiation. High Resistivity Float Zone Silicon (HRFZ-Si) is known for terahertz applications. A terahertz material may be synthetic diamond, silicon, crystals, such as crystal quartz, sapphire, polymers including, but not limited to, Polymethylpentene (TPX), ZEONEX, Polyethylene (PE), Polytetrafluoroethylene.

Nano-Captive Antennas that function similar to traditional antennas but at much smaller scales, are capable of capturing and manipulating electromagnetic waves in the visible, infrared, and even ultraviolet parts of the spectrum. This allows them to be used for various applications in areas like sensing, energy harvesting, and communication. These antennas may be used to create terahertz frequencies, or to charge the terahertz material. An exemplary nano-captive antenna is described in U.S. Pat. No. 9,088,071, to Rhett Spencer, incorporate by reference herein as a form of terahertz material or terahertz charging material.

A massage device may include a terahertz material and may have a vibrating head with terahertz material thereon or therein. The vibrating head vibrates and is configured for application to the human body to relieve muscle and tendon tightness and to massage the muscles. The terahertz material may be a coating on the vibrating head or may be incorporated into the head. A vibrating head may move or vibrate at a frequency of 30 Hz or more, about 40 Hz or more, about 50 Hz or more, about 60 Hz or more, about 70 Hz or more and any range between and including the frequencies provided, or put another way, the oscillation of the vibrating head may be expressed in RPM, such as from about 2,400-3,600 rpm, with the ideal about 3,000 rpm. A vibrating head or a portion thereof may also vibrate at higher frequencies, such as 5 KHz, about 10 KHz or more, about 25 kHz or more, about 50 kHz or more and any range between and including the values provided. Some toothbrush heads vibrate and some vibrate at more than 60 kHz.

A vibrating head of a massage device may vibrating along a vibrating axis and have a stroke length, or length of actuation along the vibrating axis of about 0.1 mm or less, about 0.25 mm or less, about 0.5 mm or less, 1 mm or less, 2 mm or less, 4 mm or less, 6 mm or less and any range between and including the values provided. If the stoke length is too small, the vibration may not be substantial enough to massage tissue and if too large, the vibrating head may be uncomfortable and may bruise tissue, and therefore a preferred range of stroke length may be about 0.5 mm to about 2 mm. However, longer stroke lengths may be also used, such as about 5 mm or more about 10 mm or more, about 20 mm or more, or even about 30 mm or more.

An exemplary massage device incorporates terahertz material in the vibrating head. The terahertz material may be a coating on the head or a component of the head or may be a separate terahertz component that is coupled with the vibrating head component. The vibrating head has a head component that extends radially out from the vibrating head shank. The vibrating head shank is coupled with the massage device and moves back and forth along a vibrating axis. A massage device may include massage implements, such as massage heads that rotate, vibrate or pivot or spin to provide actuation of the massage implement, which may include a vibrating head. A massage head may manually rotate and may be coupled to the massage device by a flexible extension. A flexible extension may have a length to enable reaching locations of a person's back and the length may be 5 cm or more, about 10 cm or more, about 15 cm or more, about 25 cm or more, or even about 50 cm or more and any range between and including the lengths provided. In an exemplary embodiment, a massage implement has three rounded heads producing a plurality of skin contact points and these heads may spin to massage a larger area of tissue without manual actuation. A massage head may be a massage ball that may be coupled with a sleeve or retainer device. A massage head may be part of a toothbrush, such as a portion of the toothbrush head or bristled portion of the toothbrush. A massage device may be a massage roller that can be rolled along a muscle, such as rolled or moved along a thigh or bicep muscle, for example.

A fixed magnet may be configured on the massage device, such as proximal to the coupling of the vibrating head shank with the massage device. A fixed magnet is stationary with respect to a head magnet that is configured on the vibrating head and moved as the vibrating head moves. The fixed magnet may be a ring magnet that extends around the shank receiver of the massage device. The head magnet is coupled to the vibrating head, such as proximal to the shank coupling with the vibrating the head component and may also be a ring magnet. The fixed and/or head magnet may be flat or planar, ring shaped or may be different shapes for various applications and devices. The fixed magnet and the head magnet may be oriented with the poles (North, South) in the same direction with respect to the vibrating axis such that they attract each other, or in an opposing orientation whereby the fixed magnet is magnetically repelled by the head magnet. In an opposing orientation, the fixed magnet may have a north pole proximal to the vibrating head or vibrating head surface and the head magnet may have a south pole proximal to the vibrating head surface, thereby having the north pole of the fixed magnet facing the south pole of the head magnet to cause magnetic attraction between the magnets. As the head magnet moves with respect to the fixed magnet, a dynamic magnetic field is created, which may be a toroidal field. This magnetic field may help to energize and relax muscles for more effective performance of the massage device. Also, there may be a plurality of fixed magnets and/or a plurality of head magnets and the magnetic orientation may all be the same or may be different. There may be one or more fixed magnets with a magnetic north facing the vibrating head and one or more fixed magnets with a magnetic south facing the vibrating head.

A dynamic magnet may move with respect to the vibrating head shank, such as being configured in a magnetic sheath and move back and forth within the magnetic sheath as the vibrating head shank actuates along a vibration axis. A dynamic magnet may be magnetic particles configured in said magnetic sheath and the magnetic particles may act as a dead-blow component. Also, a dynamic magnet may be configured around the shank of the vibrating head shank and may be a ring magnet. Magnetic stops may limit the range of motion of the ring magnet along the shank of the vibrating head shank.

The terahertz component may be configured proximal to the vibrating head surface or on the vibrating head surface, whereby it contacts a person during use. The terahertz component may be a coating or a component having a specific shape, such as a disc shape for example that is coupled to the head component, such as in a disc shaped recess on the head component vibrating head surface. The terahertz component may be charged by nano-captive antenna which may also be configured on the vibrating head such as along the shank or on the head component.

A magnetic component, a material that is attracted to a magnet, such as a magnetic metal including, but not limited to, copper, steel and the like, may also be configured on the vibrating head, such as proximal to the vibrating head surface. Both coper and silver have resonances in the THz range that may enhance stimulation and energy transfer to the person during a massage session. A magnetic component may be configured over a terahertz component. A magnetic connection component, a magnetic component that extends over the vibrating head surface and may extend down onto the vibrating head shank and may be a foil that forms a tape. Also, the head component may be wrapped with a magnetic connection component, such as a copper foil. The shank may comprise a magnetic shank component, such as a copper cylinder configured around the shank. A magnetic component may also include electrically conductive materials, wherein a current may be induced in these materials by a change in the magnetic field from the head magnet moving with respect to the fixed magnet. Electrically conductive materials including electrically conductive metals, copper, aluminum, gold, silver, and the like.

A massage implement may include a vibrating head or vibration portion that incorporates particles or powder in a chamber may more effectively transfer kinetic energy to the body through the massage implement, wherein the particles move within the chamber due to the movement or vibration of the head and the moving particles impacts the interior of the chamber to transfer kinetic energy to the massage implement.

A massage device may be a sexual massage device configured for application to the genitalia for stimulation and may be configured for insertion into the vagina or annus. A sexual massage device may have a covering, such as rubber or urethane configured over the vibrating head such that the sexual massage device, or a portion thereof, can be safely inserted into a body orifice for stimulation.

The massage implement of vibrating head may include a heater and the vibrating head may be heated to an elevated temperature, such as about 25° C. or more, about 30° C. or more, about 35° C. or more, about 40° C. or more, about 50° C. or more about 60° C. or more and any ranges between and including the values provided. Temperatures over 50° C. and especially over 60° C. can result in burns to the skin. The head may include an electrode wherein the head or a portion thereof is charged with electromagnetic energy to a voltage. A massage implement may also include or produce pulsed electromagnetic fields, such as a pulsed toroidal field, and may include lights, such as red light emitters or light emitting diodes, sound vibration devices, such as speakers, piezoelectric materials and the like. A massage implement may include a heater component that may be heated via electrical resistance heating. Also, a ferromagnetic component may be heated through induction heating by being exposed to the alternating magnetic field. A ferromagnetic component may be configured on the massage implement and proximal to a dynamic magnet that induces an alternating magnetic field.

Also, a massage implement may be electrically charged to a voltage that is safe for skin exposure and may conduct electrical current, such as micro-currents to and from the skin of the person.

The message head may be cooled or chilled to a temperature below room temperature, such as to about 2° C. or less, about 15° C. or less, about 10° C. or less, about 5° C. or less, about 0° C. or less about −10° C. or less and any ranges between and including the values provided. Direct contact with the chilled head when cooled to the lower ranges listed could result in discomfort and in some cases burns and therefore, temperatures of 5° C. to about 10° C. may be preferred. A cooled head may be chilled via a coolant that is pumped through the massage implement from the massage device body. The refrigerant may make a loop and return to the massage device body to be chilled before returning to the massage implement or massage head shank. Also, the massage head shank may be cooled by thermal conduction via contact with a heat sink that may be cooled by a refrigerant system.

Terahertz material may be included in a compression pad that is configured for application to the body. The compression pad may be configured as a compression sleeve having terahertz material to provide improved relief and therapy to an injury on a body, such as a limb. A compression pad may form sleeve having an opening for sliding over a person's limb, such as an arm or leg, or may have a sleeve seam for applying and tightening the sleeve around a limb. The sleeve seam may include a fastener, such as hook and loop fastener to allow for applying a desired amount of compression to the limb. In addition, terahertz material takes on the cold from ice quickly and can be used as a cold therapy following injury etc.

Terahertz material may be included in a therapeutic composition for application to the body. The therapeutic composition may include other therapeutic ingredients such as copper, silver, gold, diamond, rubies, bloodstone, garnet, malachite, carbon, magnets, emu oil, methyl salicylates, cayenne, turmeric, eucalyptus oil peppermint oil. The therapeutic composition may be a gel, or lotion for example and the composition may include magnetic particles.

Terahertz material may be configured as a lens for a laser. A lens that has terahertz material may affect the laser emitted therefrom. The laser light may have energized properties for improving therapy to a body, such as a limb, including removing tattoos or varicose veins calming inflammation muscle and bone, healing from scaring, overall recover.

Terahertz material may be configured with an air moving device to energize and/or ionize the air from the air moving device. An air moving device, such as a dryer may have a heating device to heat the forced air therefrom. Terahertz material may be configured in a terahertz filter, wherein the forced air is passed over the terahertz filter to ionize the emitted air to produced ionized air. The terahertz filter may be configured to detachably attach to an air moving device, such as by a sleeve configured to extend over the end of the air moving device. The sleeve may be elastic to allow the sleeve to fit over various sized air moving devices.

A therapeutic patch may include terahertz material and may also include an electromagnetic device that is configured to apply a current and voltage to the body. An electromagnetic device may include positive and negative electrode wherein current and voltage is passed through the body. A battery may be configured with the patch so that it can be operated without a wired power connection.

A sex implement may include terahertz material as a coating or within a material of the device. The sexual implement may have an elastomeric portion, such as a cover or extension and the terahertz may be included in this elastomeric portion. A sexual implement may have a motor or a vibration motor to produce vibration of the sexual implement or an extension or portion thereof. The sexual implement may include a battery and an on/off button. A terahertz material may emit radiation at a frequency that mimics the sensation of human touch and therefore may improve the pleasure experience of sexual implements.

A toothbrush head may include a massage device as described herein and include a vibration portion that may include the terahertz component and may also include a dead-blow component. A massage device that is configured as or as part of a toothbrush may vibrate at a high frequency, such as more than 25 kHz, or even about 60 kHz or more.

A mobile device cover, such as a mobile phone cover, may include terahertz material 10 and this may protect the user of the mobile device from electromagnetic energy and radiation. The mobile cover is configured to extend around the mobile device but leave an opening for a display screen. A terahertz material may block electromagnetic radiation and may therefore protect a mobile device from unwanted synching with other devices. Also, the terahertz radiation may provide more effective mental benefits as the mobile device may be held proximal to a person's head, proximal to the brain, where the terahertz radiation may calm a person and provide mental clarity and energy.

The terahertz material may be combined with copper and/or silver for improved properties, such as electrical and/or thermal conductivity. These metals may also enhance the introduction of energy from the terahertz into the body.

Terahertz material is a material with an embedded frequency in the terahertz range and as described herein, may be a material including, but not limited to, crystals, such a crystal quartz, silicon, sapphire. Also, a terahertz material may be combined with other material such as metals including copper, gold, or silver. Copper may be combined with a terahertz material for anti-inflammatory benefits and silver may be combined for antimicrobial power stones. A terahertz material may emit radiation or energy in the terahertz frequency range and this may impart this energy into other materials, tissues, liquids, gas and the like.

Terahertz sone is manmade. Invented by scientist in Japan in order to protect the body against electromagnetic smog (the positive charge of EMF) and harmful radiation. Leading to the idea of a possibility as solution to harmful charges coming from our electronic devices. (The frequency of healthy tissue in the terahertz (THz) range varies depending on the specific tissue type and properties. Terahertz radiation falls within the frequency range of about 0.1 to 10 THz, which corresponds to wavelengths ranging from 30 μm to 3 mm.)

A terahertz material may be configured in a bandage including, but not limited to:
Adhesive Bandages (Plasters): These are small, flexible bandages with an adhesive backing used to cover minor cuts, scrapes, and wounds. They are commonly known as band-aids.
Gauze Bandages: Gauze bandages are made of woven or non-woven cotton fabric and are used for wound dressing, padding, and securing dressings in place. They come in various widths and lengths.
Elastic Bandages: Elastic bandages, also known as compression bandages, are stretchable bandages used to provide support, compression, and immobilization for sprains, strains, and other injuries. They are often made of elastic or elastic-cotton blend materials.
Triangular Bandages (Cravats): These are large, triangular-shaped bandages made of cotton or muslin fabric. They are versatile and can be used as slings, tourniquets, splints, or for securing dressings in place.
Self-Adhering Bandages (Cohesive Bandages): These bandages adhere to themselves without the need for clips or tape. They are commonly used for compression, support, and securing dressings without sticking to the skin or hair.
Transparent Film Dressings: These thin, transparent bandages are made of breathable, waterproof film material and are used for covering and protecting minor wounds, burns, and IV sites. They allow for easy monitoring of the wound without removal.
Foam Dressings: Foam bandages are highly absorbent and are used for moderate to heavily draining wounds. They provide cushioning, protection, and moisture management for wounds.
Hydrocolloid Dressings: Hydrocolloid bandages are adhesive dressings that contain gel-forming agents such as gelatin or pectin. They create a moist environment conducive to wound healing and are used for shallow wounds and pressure sores.
Alginate Dressings: Alginate bandages are made from seaweed-derived fibers and are highly absorbent. They are used for heavily draining wounds, such as ulcers and surgical wounds, to promote wound healing.
Compression Wraps: These are specialized bandages designed to provide graduated compression for managing conditions such as venous insufficiency, lymphedema, and edema.
Finger and Toe Bandages: These are small, tubular bandages designed specifically for fingers and toes. They provide protection and cushioning for injuries, blisters, or surgical sites.
Occlusive Dressings: Occlusive bandages are air-and water-tight dressings used for creating a moist wound environment and promoting healing. They are often used for burns, skin grafts, and certain types of wounds.

A terahertz material may be configured with or on a gas production machine, such as an ozone generator or oxygen generator to impart terahertz frequency into the gas. Ozone is used in various therapeutic applications to heal wounds, relieve pain and treat disease. Ozone may be administered as a gas to the outside of a person, or through a wrap or other implement to direct the ozone to a specific location on a person's body or inhaled at low concentrations. Also, ozone may be injected or otherwise introduced into a person's body through absorption. Oxygen may be administered in a similar manner and also inhaled.

A terahertz component or material may be configured as a layer or in a pattern to created specific energy patterns including, but not limited to, Tesseract, including 18 and 24 point Tesseract pattern, Lakhovsky MWO, flower of life, torus pattern, spiral pattern and the like. The pattern may be a pattern in the terahertz material or the terahertz material may be deposited or configured in said pattern. For example, the terahertz material may be coated onto a surface, such as a plate having a planar surface for receiving the pattern of terahertz material. Also, the terahertz may be configured in a shape or as a coating or layer on a shaped object, such as a sphere, a cube, a triangle, a pyramid shape and the like.

A terahertz material may be used in any of the devices to stimulating stem cell proliferation in hair cells. A terahertz material may be configured on a cap or head cover to emit energy onto the scalp for hair regrowth and for maintaining health of hair. The terahertz may emit energy onto the scalp.

Terahertz material may be incorporated into handles of implements, hand implements, to provide improved power, stamina and/or accuracy. The handle of the implement is configured for a person to hold and operate the implement by hand by the handle. Terahertz may be incorporated into a handle material or coated onto a handle such as a handle of hand tools, outdoor sporting equipment, or competitive sporting equipment. The terahertz material may create negative ions. Materials that make up negative ion products include Germanium, conductive silicone, carbon fiber, thorium, uranium or tourmaline. The terahertz material may be up THZ Germanium Quartz silicone.

An implement may be a hand tool, outdoor sporting equipment, competitive sporting equipment, Olympic sporting equipment and the like.

For hand tools, such as hammers, drills, wrenches, and the like or garden hand tools such as shovels, picks, rakes and the like, the terahertz material may provide increased power and stamina.

For outdoor sporting equipment, such as hunting and fishing equipment, firearms, such as handguns, rifles, bows, fishing rods, slingshots, spears, fishing rods and the like may include terahertz material on the handles, or hand interfaces to provide increase stamina, and accuracy.

For competitive sporting equipment, such as racquets, bats, clubs, sticks, such as lacrosse sticks, oars, javelins, poles for pole vaulting, hammers for hammer throw, discs for disbars, dumbbells, wrist wraps, such as for weight lifting or rowing, mallets, mitts, and the like may incorporate terahertz material on the handles and may help improve power, stamina and accuracy of the person using the competitive sporting equipment.

The summary of the invention is provided as a general introduction to some of the embodiments of the invention and is not intended to be limiting. Additional example embodiments including variations and alternative configurations of the invention are provided herein.

### BRIEF DESCRIPTION OF SEVERAL VIEWS OF THE DRAWINGS

The accompanying drawings are included to provide a further understanding of the

invention and are incorporated in and constitute a part of this specification, illustrate embodiments of the invention, and together with the description serve to explain the principles of the invention.

FIG. 1 shows a massage device having a vibrating head with terahertz material that vibrates and is configured for application to the human body to relieve muscle and tendon tightness and to massage the muscles.

FIG. 2 shows a side view of a massage device having a vibrating head with a terahertz component and magnet and a magnetic component that vibrates and is configured for application to the human body to relieve muscle and tendon tightness and to massage the muscles.

FIG. 3 shows an end view of the vibrating head shown in FIG. 19 having a terahertz component.

FIG. 4 shows an exemplary massage device that incorporates terahertz material in the vibrating head and a pair of magnets that produce electromagnetic fields.

FIG. 5 shows an exemplary massage device that incorporates terahertz material in the vibrating head and a dynamic magnet that moves within a magnetic sheath to produce electromagnetic fields and electrical currents.

FIG. 6 shows an exemplary massage device that incorporates terahertz material in the vibrating head and a dynamic magnet that moves within a magnetic sheath to produce electromagnetic fields and electrical currents and also a dead-blow component that incorporates particles within a chamber to improve the transfer of kinetic energy of the head to tissue.

FIG. 7 shows a side view of an exemplary massage device that incorporates terahertz material in a plurality of vibrating heads, each having a dynamic magnet that moves with vibration portion of the massage device and a fixed magnet to produce magnetic fields.

FIG. 8 shows a top view of the exemplary massage device shown in FIG. 7 having a massage implement aligned with the vibrating axis or length axis of vibrating head shank and three other heads extending radially out from this length axis.

FIG. 9 shows a sexual implement having terahertz material that emits terahertz frequency.

FIG. 10 shows an electro-stimulation pad that includes a terahertz material.

FIG. 11 shows a perspective view of a terahertz speaker, a wrist speaker that is coupled to a person.

FIG. 12 shows an exploded view of an exemplary terahertz speaker having a terahertz material that vibrates when the speaker produces sound and in turn produces electrical fields and current.

FIG. 13 shows a therapeutic patch having terahertz material which may also include an electromagnetic device that is configured to apply a current and voltage to the body.

FIG. 14 shows a compression wrap having terahertz to provide improved relief and therapy to an injured limb and has a sleeve seam for applying and tightening the sleeve over a limb.

FIG. 15 shows a therapeutic composition including terahertz material that is applied to the body.

FIG. 16 shows a laser having a lens with terahertz material to affect the laser emitted therefrom.

FIG. 17 shows an air moving device, a dryer, configured with a terahertz filter, wherein the forced air is passed over the terahertz filter to ionize the emitted air.

FIG. 18 shows a front view of a mobile device in a mobile device cover having terahertz material that emits terahertz frequency.

FIG. 19 shows a back view of the mobile device show in FIG. 7, with the mobile device cover having terahertz material.

FIG. 20 shows a sleeping bag that incorporates terahertz material, such as a liner, fiber or yarn or batting.

FIG. 21 shows a head covering that incorporates a terahertz material therein, such as a liner, fiber, yarn and the like.

FIG. 22 shows a garment that incorporates terahertz material therein, such as a liner, fiber, yarn and the like.

FIG. 23 shows a perspective view of an exemplary ozone therapeutic treatment apparatus having a plurality of ozone introducers, a magnetic ozone interface, and an ozone injector to implant ozone into the body through the skin, and a second magnetic ozone interface that produces a magnetic field opposite the first magnetic ozone interface to draw the ozone through the body toward the second magnetic ozone interface.

FIG. 24 shows a perspective view of a sauna treatment apparatus having an enclosure and a head opening.

FIG. 25 shows a perspective view of a person having blood drawn treated by an ozonating blood apparatus to add ozone to the blood and produce ozonated blood that may be then returned to the person.

FIG. 26 shows a side view of an exemplary magnetic ozone interface having a ring magnet coupled to an ozone cup assembly having an internal ozone cup surrounded by a collection cup.

FIG. 27 shows a bottom view of an exemplary ring magnet having a center aperture surrounded by a magnet.

FIG. 28 shows a perspective view of an exemplary magnetic ozone interface wrapped around a person's limb, their leg and comprising an internal ozone cup and collection cup configured around the collection cup, and a magnet configured over a treatment location.

FIG. 29 shows hand tools with terahertz material configured on the handle or handles.

FIG. 30 shows outdoor sporting equipment having terahertz material configured on the handle or handles.

FIG. 31 shows competitive sporting equipment with terahertz material configured on the handle.

FIG. 32 shows a toothbrush with a toothbrush head that includes a terahertz material and the toothbrush head may be a massage implement comprising a terahertz material that emits radiation between 0.1-10 THz (3 mm to 30 μm), between microwave and far infrared spectral region.

FIG. 33 shows a stimulation article, such as a disc, including terahertz material, magnets, and copper element.

FIG. 34 shows a side cross-sectional view of a vibrating head shank that has magnetic particles configured in a magnetic sheath and a terahertz component configured on the vibrating head surface.

Corresponding reference characters indicate corresponding parts throughout the several views of the figures. The figures represent an illustration of some of the embodiments of the present invention and are not to be construed as limiting the scope of the invention in any manner. Some of the figures may not show all of the features and components of the invention for ease of illustration, but it is to be understood that where possible, features and components from one figure may be included in the other figures. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

### DETAILED DESCRIPTION OF THE ILLUSTRATED EMBODIMENTS

As used herein, the terms “comprises,” “comprising,” “includes,” “including,” “has,”“having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Certain exemplary embodiments of the present invention are described herein and are illustrated in the accompanying figures. The embodiments described are only for purposes of illustrating the present invention and should not be interpreted as limiting the scope of the invention. Other embodiments of the invention, and certain modifications, combinations and improvements of the described embodiments, will occur to those skilled in the art and all such alternate embodiments, combinations, modifications, improvements are within the scope of the present invention.

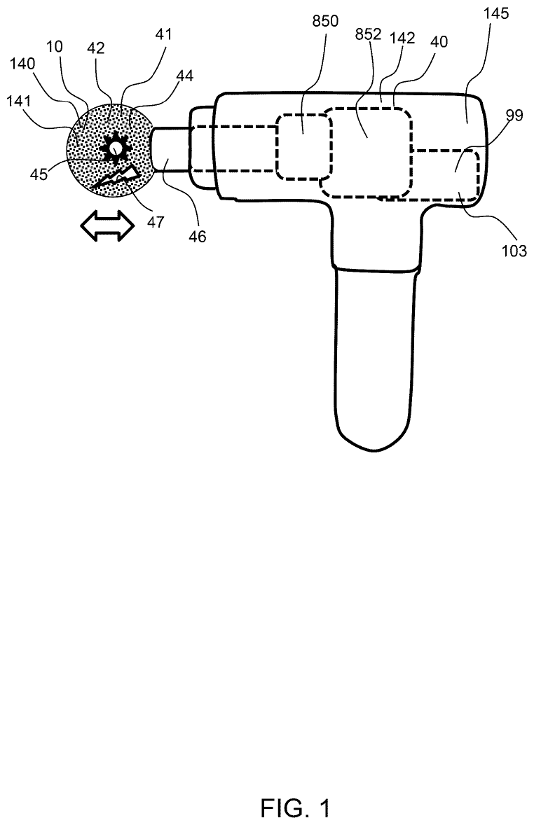

As shown in FIG. 1, a massage device 40 has a vibrating head 42, a massage implement 140, with terahertz material 10 configured thereon such as a coating 44 of terahertz material or a terahertz component. The massage implement 140 vibrates and is configured for application to the human body to relieve muscle and tendon tightness and to massage the muscles. The terahertz material 10 may be a coating 41 on the vibrating head or may be incorporated into the head. The head may include a heater 45 and the vibrating head may be heated to an elevated temperature, such as about 25° C. or more, about 30° C. or more, about 35° C. or more, about 40° C. or more, about 50° C. or more about 60° C. or more and any ranges between and including the values provided. Temperatures over 50° C. and especially over 60° C. can result in burns to the skin. The head may include an electrode 47 wherein the head or a portion thereof is charged with electromagnetic energy to a voltage. A massage device may be a ball, or belt or pad or any other suitable configuration for applying vibration to a body. The vibration and oscillating movement of the massage implement may charge the terahertz material. A terahertz massage implement or device may improve muscular release, especially when combined with copper or other materials. A massage implement may be shaped to amplify the benefits of the terahertz material and may be spherical or conical in shape, or pyramidal in shape.

A vibrating head 42 may include the terahertz material 10 and other materials that may have therapeutic benefits, such as copper, diamonds, rubies, copper, bloodstone, garnet, malachite and carbon.

An exemplary massage implement or vibrating head, such as a spherical ball may be configured on a massage gun, as shown, or may be included in a back roller, vibrating ball, vibrating foam rollers, vibrating foot massage, calf massage roller, electric fat massage roller, vibrating scalp massagers for hair growth, vibrating massage belts, massage chairs/seat cushions, sound beds, vibrating massage mats and/or normatec type products. As shown, the massage gun 142 has a vibrating portion 141 that vibrates with respect to the massage device body 145. The vibrating head 42 moves back and forth via movement of a vibrating head shank 46 that moves with respect to the massage device body. A massage gun 142 typically utilizes a motor 852 that moves the vibrating head shank 46 back and forth to produce the vibrator implement 850. A vibrator implement 850 may also employ a motor to move an eccentric mass, or an eccentric mass vibrator which is well known for massage devices. Finally, a vibrator implement 850 may incorporate a piezoelectric vibrator, also well known for higher frequency vibration devices. The length of the vibrating head shank may be about 10 mm or more, about 20 mm or more, about 50 mm or more, and any range between and including the lengths provided.

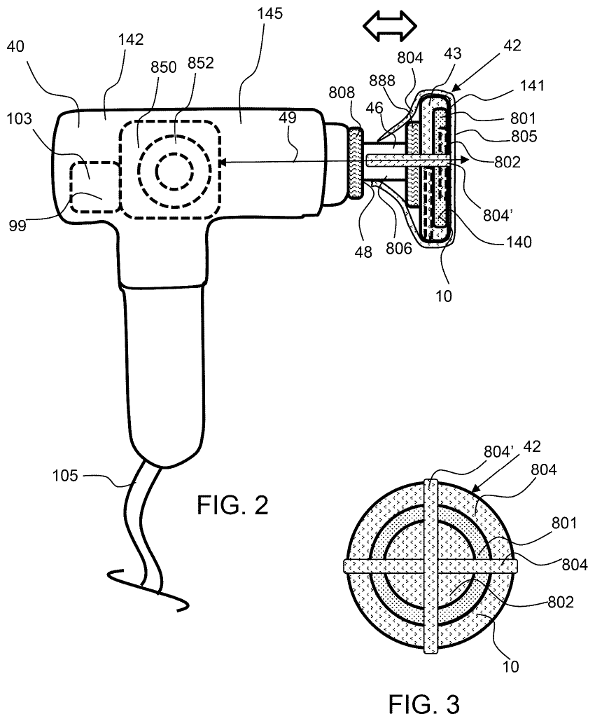

Referring now to FIGS. 2 to 4, an exemplary massage device 40, or massage implement 140, incorporates terahertz material 10 in the vibrating head 42, an example of a massage implement 140. The vibrating head 42 has a head component 43 that extends radially out from the vibrating head shank 46. The vibrating head shank is coupled with the massage device 40 and moves back and forth as indicated by the bold double arrow. A fixed magnet 808 is configured on the massage device body 145, and the vibrating head shank may extend through this fixed magnet, which may be a ring magnet. The fixed magnet is stationary with respect to a head magnet 888 that is configured on or more proximal to the vibrating head and moves as the vibrating head moves. The fixed magnet may be a ring magnet that extends around the shank receiver 48 of the massage device. The head magnet 888 is coupled to the vibrating head 42 and may also be a ring magnet. The fixed magnet and the head magnet may be oriented with the poles (North, South) in the same direction with respect to the vibrating axis 49 such that they repel each other, or in an opposing direction whereby the fixed magnet is magnetically attracted to the head magnet. As the head magnet moves with respect to the fixed magnet, a dynamic magnetic field is created. This energy field may help to energize and relax muscles for more effective performance of the massage device. Also, there may be a plurality of fixed magnets and/or a plurality of head magnets and the magnetic orientation may all be the same or may be different. There may be one or more fixed magnets with a magnetic north facing the vibrating head and one or more fixed magnets with a magnetic south facing the vibrating head.

The magnets may be permanent magnets or electromagnets that are powered by a power source 103, such as a battery 99 or wall outlet coupled to the massage device by a power cord 105, shown in FIG. 2.

The movement of the head magnet with respect to the fixed magnet may produce a pulsed electromagnetic field that may impart electrical current in the magnetic material components or in a person's tissue or skin.

The terahertz component 801 may be configured proximal to the vibrating head surface 805 or on the vibrating head surface, whereby it contacts a person during use. A magnetic component 802 may also be configured on the vibrating head 42, such as proximal to the vibrating head surface 805. As shown, the magnetic component 802 is configured over the terahertz component 801. As shown, a magnetic connection component 804 extends over the vibrating head surface 805 and down onto the vibrating head shank 46, and may be copper foil, such as a copper electroplated layer or a thin planar layer of metal. This magnetic connection component electrically couples the vibrating head to the shank at a location offset from the vibrating head. Also, the head component may be wrapped with a magnetic connection component, such as a copper foil. The shank may comprise a magnetic shank component 806, such as a copper cylinder configured around the shank.

As described herein, the magnetic components may be material that are attracted to a magnet and maybe electrically conductive, such as copper, and may have an induced electrical current from the movement of the fixed magnet with respect to the head magnet.

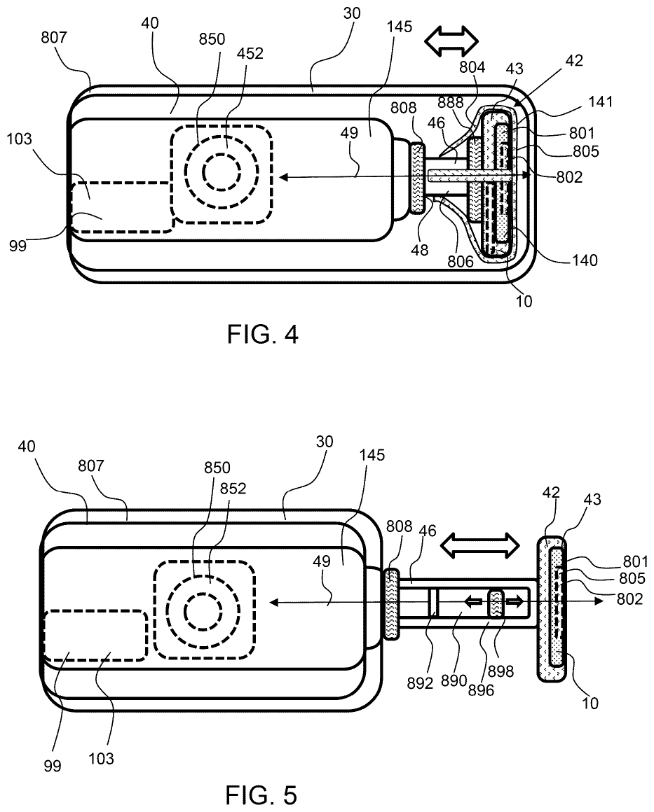

As shown in FIG. 4, a cover 807 extends over the vibrating head 42 and down onto the massage device body 145 and may enclose the vibrating head and the vibrating head shank 46. The cover may be an elastomeric cover to allow the vibrating head to stretch the cover from the massage device body 145.

As shown in FIG. 5, a terahertz component 801 may be configured proximal to the vibrating head surface 805 or on the vibrating head surface, whereby it contacts a person during use. A magnetic component 802 may also be configured on the vibrating head 42, such as proximal to the vibrating head surface 805. As shown, the magnetic component 802 is configured over the terahertz component 801. Also, a dynamic magnet 898 is configured within the magnet sheath 896, which may be a vibrating head shank 46 and may move or slide back and forth within the sheath to produce eddy currents within the magnet sheath, which may be an electrically conductive material such copper. Copper has negative ion properties which may be preferred but other materials may also be used including, but not limited to, silver, gold, aluminum germanium, conductive silicone, carbon fiber, thorium and uranium, or tourmaline, which may be cylindrical in shape with a circular magnet conduit 890 or may be coated onto another material. The dynamic magnet moves back and forth within the magnet sheath when the vibrating head shank 46 moves. The magnet sheath may form a portion of or may be the vibrating head shank. A magnet stop 892 is configured in the magnet conduit 890 to limit the range of motion of the dynamic magnet. As the dynamic magnet moves it creates magnetic fields. When the magnet sheath is an electrically conductive material, such as copper, an electrical current is produced in the magnet sheath when the dynamic magnet moves within the magnet sheath. A fixed magnet 808 is configured on the massage device body 145 and may magnetically interface with the dynamic magnet, wherein it either attracts the dynamic magnet or repels the dynamic magnet.

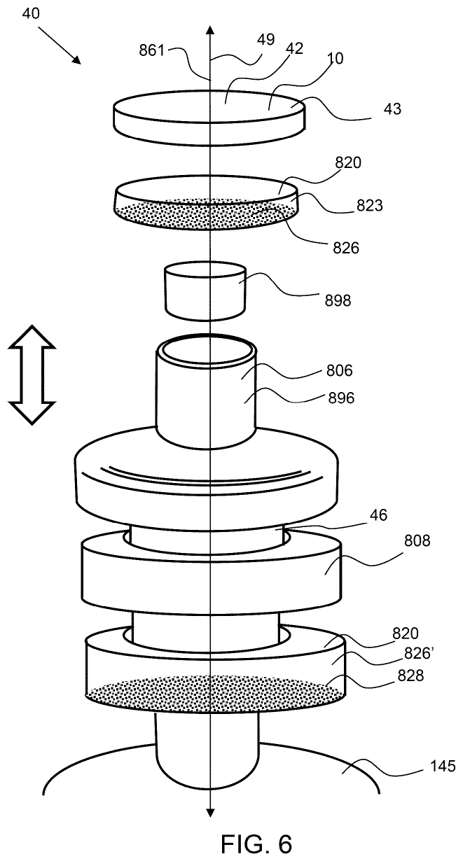

As shown in FIG. 6, an exemplary massage device 40, or massage implement 140, incorporates terahertz material 10 in the vibrating head 42, an example of a massage implement 140. The vibrating head 42 has a head component 43 that extends radially out from the vibrating head shank 46. This massage implement includes a magnet sheath 896, which may incorporate the vibrating head shank 46, and a dynamic magnet 898 that fits within and moves or slides within the magnet sheath when the vibrating head shank 46 moves back and forth. A fixed magnet 808 is configured an offset distance from the dynamic magnet and this offset distance changes as the dynamic magnet moves within the magnet sheath. The fixed magnet is fixed to the massage device body and does not move with the vibrating head shank.

One or more dead-blow components 820, 820′ may be configured on the vibrating head shank 46 to transfer kinetic energy to the body through the vibrating head and reduce recoil of the vibrating head 42, wherein a dead-blow particles 826, 426′, respectively, are configured within a chambers and move within the chamber to reduce recoil and to transfer kinetic energy to tissue through the vibrating head 42. A head dead-blow component 823 may be coupled with or be adjacent the vibrating head 42 and may be a chamber containing dead-blow particles 826, such as a terahertz, quartz, copper, silver copper or metal powder. A high density particle may be preferred, such as a metallic particle, or particles made of or containing terahertz material, wherein terahertz has a density of about 2.1 g/cc. A shank dead-blow component 828 may be configured along the shank more proximal to the massage device body 145 and may also move with the vibrating head shank 46 and may be a chamber that retains a dead-blow particles 826′, such metallic particle or particles made of or containing terahertz material.

As shown in FIG. 6, a dynamic magnet 898 is configured in a magnet sheath 496 and moves with respect to the vibrating head shank 46 within the magnet sheath, along the vibrating axis 49 or length axis 861 of the vibrating head shank 46.

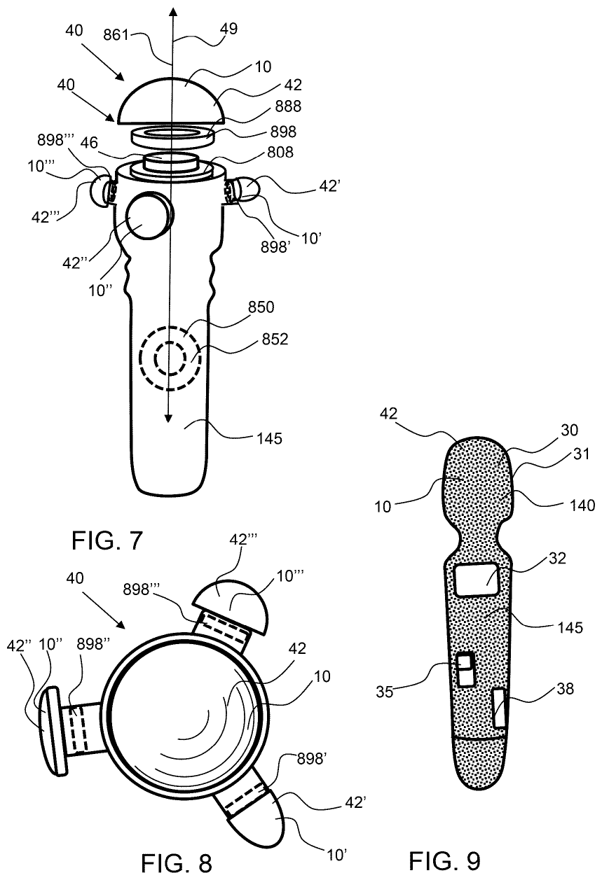

As shown in FIGS. 7 and 8, an exemplary massage device 40 that incorporates terahertz material in a plurality of vibrating heads 42, 42′, 42″, 42′″, each having a dynamic magnet 898, 898′, 898″, 898′″ that moves with the vibration portion of the massage device and a fixed magnet 808 to produce magnetic fields such as toroidal magnetic fields. One of the vibrating heads 42 is aligned with the vibrating axis 49 or length axis 861 of vibrating head shank and three other vibrating heads 42′, 42″, 42′″ extend radially out from this length axis, and each has a different shaped vibrating head. A vibrator implement 850, such as motor 852 is configured in the massage device body and the vibrating head shank 46 moves or vibrates along the length axis 861 of the vibrating head shank.

As shown in FIG. 9, a sex implement 30, and example of a massage implement 140, may include terahertz material 10 as a coating or within a material of the device. The sexual implement may have an elastomeric portion 31, such as a cover or extension over the massage device body 145 and/or the vibrating head 42, and the terahertz may be included in this elastomeric portion 31. A sexual implement may have a motor 32 or a vibration motor 37 to produce vibration of the sexual implement or an extension or portion thereof. The sexual implement may include a battery 38 and an on/off button 35. An eccentric mass vibration device may be used with a sex implement.

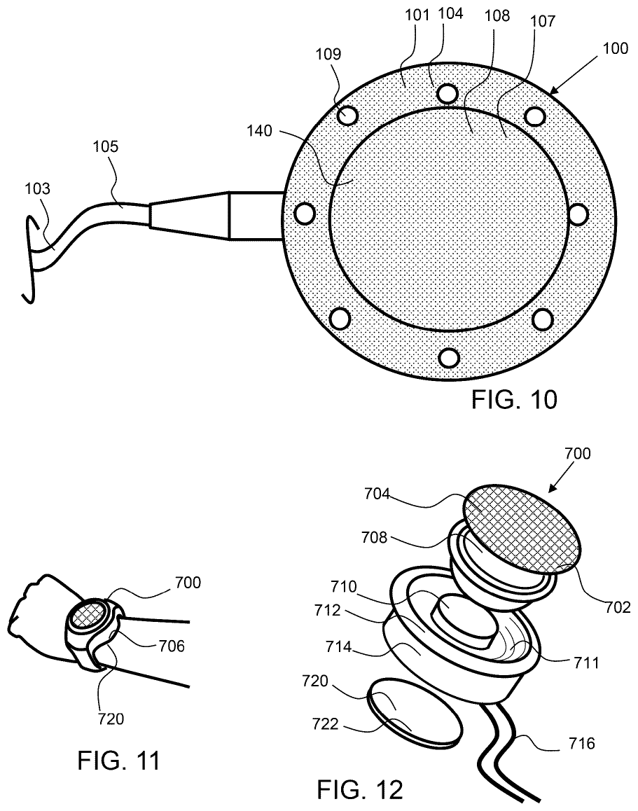

As shown in FIG. 10, an electro-stimulation pad 100 may comprise a terahertz material 101, such as a coating or sheet of terahertz material. Also, the electro-stimulation pad may include a magnet 108 and/or lights 109. The lights may be configured on the skin contact surface 104 or to emit light from the skin contact surface onto skin or a therapeutic location. The magnets may be electro-magnets 107 that are powered by an electrical power source 103, such as power from power cord 105 to have a variable magnetic field strength emitted from the electromagnet. The magnets may produce a wave of magnetic field to interacts with tissue by creating different vibrations allowing for electricity, vibrations, sound/ultrasound. The lights may be therapeutic lights that emit red light wavelengths, and/or green light wavelength for example. Red light has a wavelength of between about 620 to 750 nm and green light has a wavelength of between about 495 nm to 570 nm.

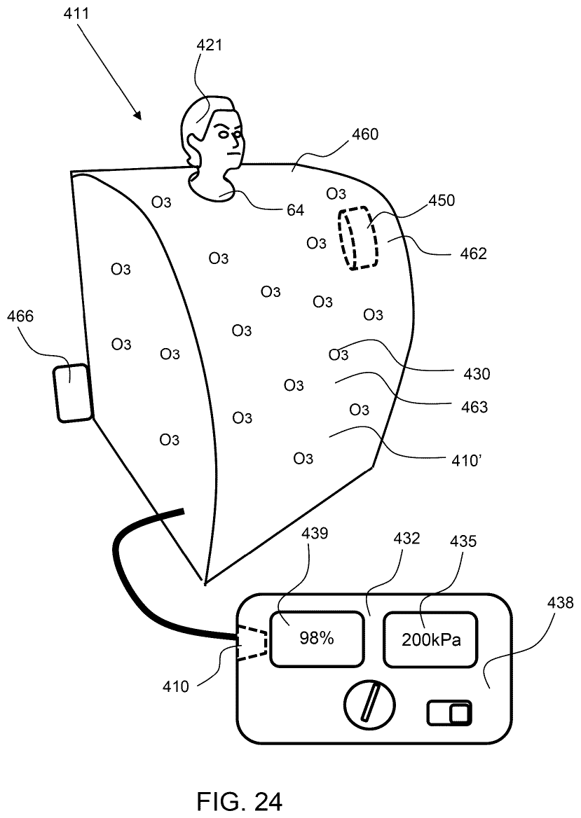

As shown in FIGS. 11 and 12, a terahertz speaker 700 is configured with a terahertz material 720, such as a terahertz disc 722 that is configured proximal to the person or user to produce and transfer electromagnetic energy, such as electrical fields and/or electrical current to the user. The terahertz material may be configured on an exterior surface of a speaker 702 or speaker housing 706 and the housing may be configured against a person's skin as shown in FIG. 24. A terahertz speaker has a speaker emission side with a speaker sound cover 704 for emitting sound therethrough. Also, the terahertz speaker has a diaphragm 708 that vibrates to produce sound waves and sound, a diaphragm suspension to allow the diaphragm to vibrate with in the diaphragm retainer. A voice coil 710 is coupled to a spider 711 that extends to the basket 712 that retains the voice coil within the magnet 714, which is a ring magnet having a magnet aperture wherein the voice coil extends at least partially therein. Current is provided to the voice coil 710 by electrical leads 716 and travels in a coil that produces a magnetic field that causes the voice coil to move within the magnet. The terahertz material 720, such terahertz disc 722 is configured proximal to the magnet and the vibration from the movement of the magnet produces electrical fields and current to be produced by the terahertz material. These electrical fields and current may be transferred to person for therapeutic purposes.

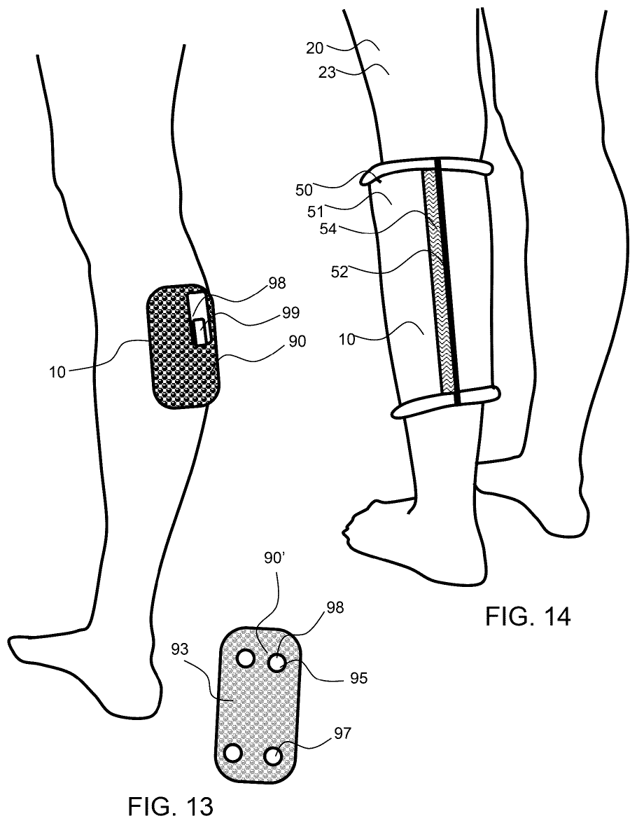

As shown in FIG. 13, a therapeutic patch 90 has terahertz material 10 and may also include an electromagnetic device 98 that is configured to apply a current and voltage to the body. An electromagnetic device 98 may include positive electrodes 95 and negative electrodes 97 wherein current and voltage is passed through the body 20. A battery 99 may be configured with the patch 90 so that it can be operated without a wired power connection. A second therapeutic patch 90′ shows a skin contact surface 93.

As shown in FIG. 14, shows a compression pad 50, is configured as a compression sleeve 51 having terahertz material 10 to provide improved relief and therapy to an injury on a body 20, such as a limb 23. A compression pad 50 may form sleeve having an opening for sliding over a person's limb, such as an arm or leg, or may have a sleeve seam 52 for applying and tightening the sleeve around a limb. The sleeve seam may include a fastener 54, such as hook and loop fastener to allow for applying a desired amount of compression to the limb. The compression garment may be used in cold or heated compression.

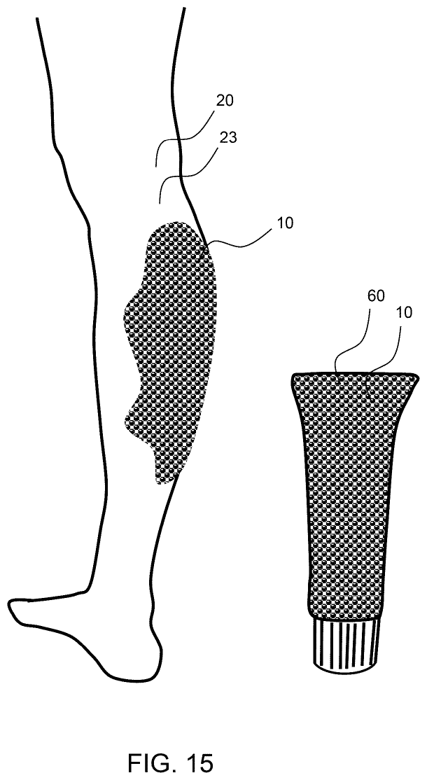

As shown in FIG. 15, a therapeutic composition 60 includes terahertz material 10 that is applied to the body. The therapeutic composition may include other therapeutic ingredients such as anti-inflammatory, copper, silver, antifungal, antibacterial and the like. The therapeutic composition may be a gel, or lotion for example.

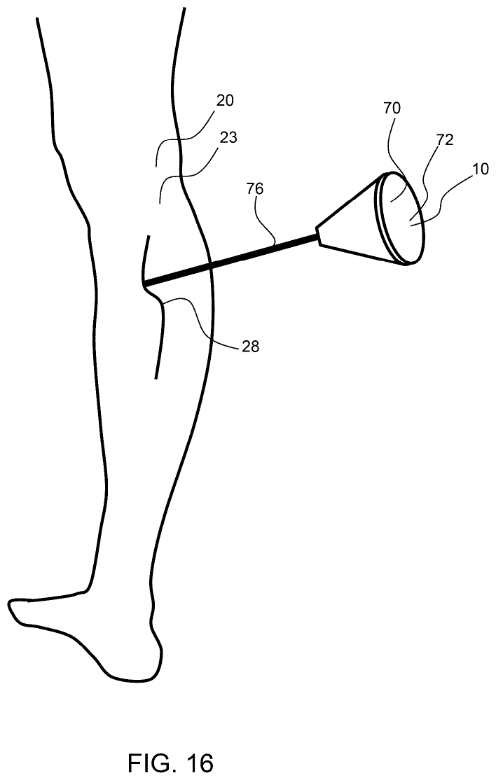

As shown in FIG. 16, a laser 70 has a terahertz material lens 72 with terahertz material 10 therein to affect the laser emitted therefrom. The laser light 76 may have energized properties for improving therapy to a body 20, such as a limb 23, including removing tattoos or varicose veins 28.

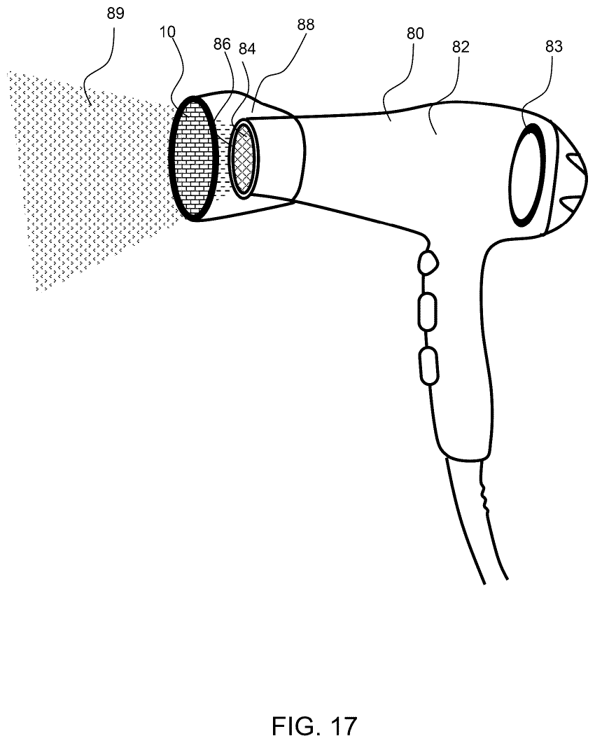

As shown in FIG. 17 an air moving device 80, a dryer 82 having a heating device 83 is configured with a terahertz filter 86 having terahertz material 10, wherein the forced air 84 is passed over the terahertz filter to ionize the emitted air to produce ionized air 89. The terahertz filter may be configured to detachably attach to an air moving device 80, such as by a sleeve 88 configured to extend over the end of the air moving device. The sleeve 88 may be elastic to allow the sleeve to fit over various sized air moving devices.

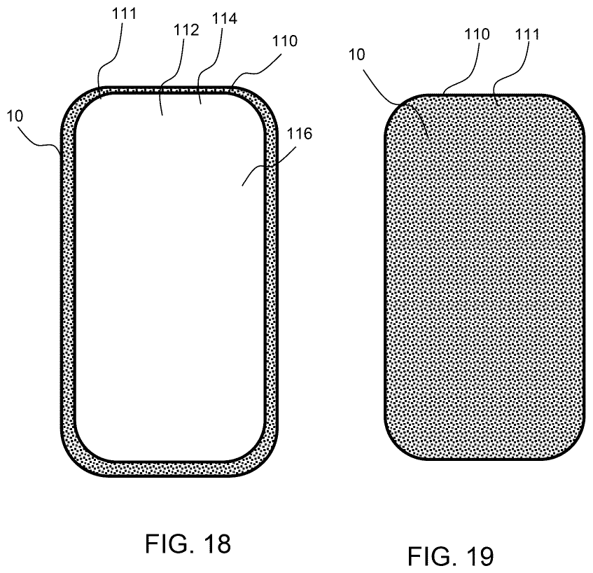

As shown in FIGS. 18 and 19, a mobile device cover 110, such as a mobile phone cover 111, may include terahertz material 10 and this may protect the user of the mobile device from electromagnetic energy and radiation. The mobile cover is configured to extend around the mobile electronic device 112 but leave an opening for a display screen 114. In addition to a mobile device cover, a terahertz material may be a casing on other electronic devices, such as cell phone casing, that a person may place their cell phone when not in use, or a cover as shown in FIGS. 18 and 19. A mobile device case may form a full enclosure or substantially full enclosure, more than 75% over the mobile device surface area to prevent radiation from being emitted from the mobile device and radiation or wireless signals from connecting with the mobile device. A terahertz material may be configured around headphones or audio earbuds. The Terahertz material may allow Bluetooth communication but may stop the negative effects of positive charged electromagnetic frequency.

In an exemplary embodiment, a terahertz material extends over a display screen 114 of an electronic device, such as a mobile electronic device 112 and may be a transparent terahertz screen cover 116 that enables a person to view content on the display screen 114 through the transparent terahertz screen cover 116. The transparent terahertz screen cover 116 may prevent harmful radiation from the electronic display from harming a person's eyes. A transparent terahertz screen cover 116 may be configured over computer screens, smart-watch screens, television screens as well as other types of electronic display screens including touch screens.

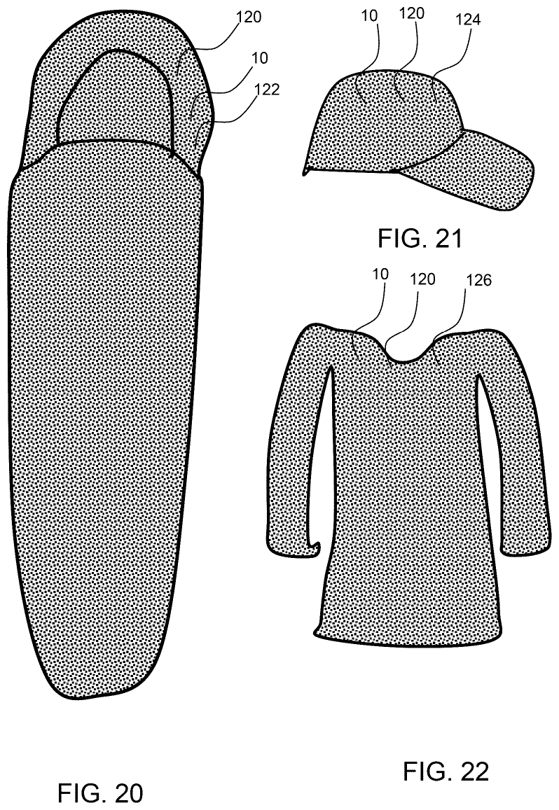

FIG. 20 shows a terahertz fabric 120 configured into a sleeping bag 122 that incorporates terahertz material 10, such as in the fabric liner, or fiber of the fabric or yarn or batting.

FIG. 21 shows a head covering 124 that incorporates a terahertz material 10 therein, such as a terahertz fabric 120 that incorporates the terahertz material 10 in a fabric liner, fiber, yarn and the like.

FIG. 22 shows a garment 126 that incorporates a terahertz material 10 therein, such as terahertz fabric 120 that includes terahertz material in the fabric liner, fiber, yarn and the like. A terahertz garment includes, but is not limited to, a shirt, pants, shorts, undergarment, socks, gloves, scarf, jacket, dress, shoes, tie, t-shirt and the like. A terahertz material may be included in a shoe insert and may be a polymeric material that provides cushioning and terahertz frequencies to the sole of the foot. This may provide therapeutic benefits to the entire body.

Some other garments or wearable implements including but are not limited to: weight belts, posture corrector, wrist brace, plantar Fasciitis nigh stock, stretching bands, recover calf sleeves, metatarsal pads, shoe insert, groin thigh sleeve and hip support wrap, padded arch support, long arthritis gloves, finger splint or wrist wrap, recovery thumb brace, post op equipment—shoulder brace, knee brace, face masks, garments leggings, head covering, beanies and the like.

A terahertz material may be incorporated into jewelry including, but not limited to, necklaces, bracelets, earrings, broaches, pendants, piercing studs, nose rings, and the like. The terahertz material may be included with other metals, or a gem type material, such as a synthetic diamond, sapphire and the like.

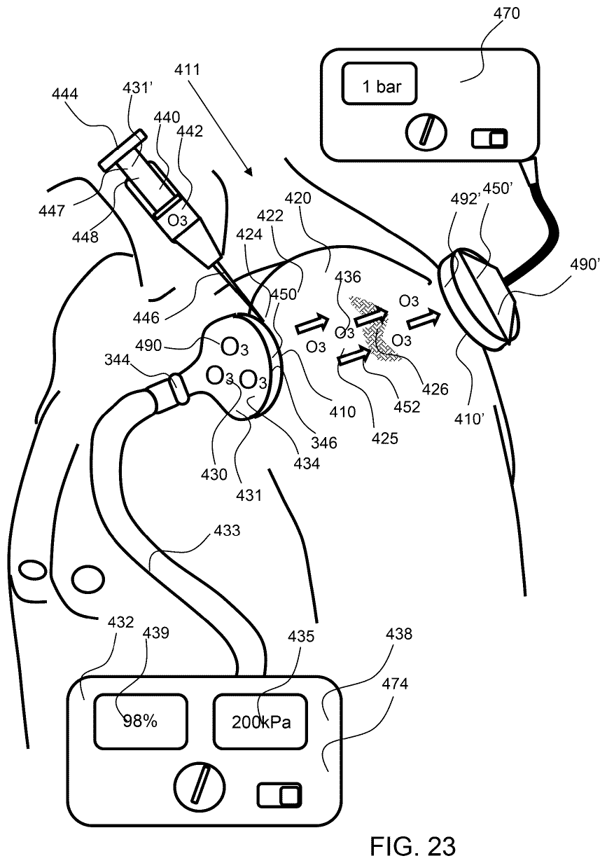

Referring now to FIGS. 23 to 25, an exemplary ozone therapeutic treatment apparatus 411 may include a terahertz material 410 that is configured to impart terahertz frequency to ozone that is introduced into the body. The terahertz material 410, 410′ may be configured on a magnetic ozone interface 490, 490′, such as proximal to the contact surface, or surface configured for contact with the person.

With reference to FIG. 23, an exemplary ozone therapeutic treatment apparatus 411 has a plurality of ozone introducers 431, 431′, a magnetic ozone interface having an ozone cup 434 and a magnet 450, and an ozone injector 440 to implant ozone into the body 420 through the skin 422. A second magnetic ozone interface 490′ has a second magnet 450′ which may be a porous magnet 492 that allows gas to flow through the magnet. The first magnet 450 may produce a magnetic field that forces or drives the ozone into the body and the second magnet 450′, such as a porous magnet 492′ may produce a magnetic field 452 to draw the ozone 430 and the internal ozone 436, the ozone implanted in the body, through the body toward the second magnetic ozone interface 490′. The internal ozone 436 moves from the ozone introducer(s) or implanted area toward the second magnetic ozone interface 490′ across a treatment condition 425, scar tissue 426 of the shoulder joint. Ozone is known as an effective treatment for breaking up scar tissue and relieving the symptoms of frozen shoulder and actively moving the ozone across and or through the joint via the magnetic field enhances the effectiveness of this treatment.

The ozone cup 434 of the first magnetic ozone interface 490 has an inlet end 344 that is coupled with an ozone source 432, such as an ozone generator 438, which may be used to control the ozone concentration 39 and/or the ozone pressure 35 supplied to the ozone introducer 431. The ozone cup 434 has an interior volume for the received ozone 430 and an application end 346 configured to dispense the ozone to a treatment location 424 through an opening in the application end. Note that the ozone generator may be coupled with the ozone injector 440 as well to provide a flow of ozone into the body through the needle 446. The ozone injector 440 has an internal receptacle 442 for retaining or receiving ozone 430 and a plunger 444 to force the ozone through the needle and into the body 420. The ozone injector 440 may be a jet injector 447 that utilizes a pressurizing device 448 to introduce the ozone 430 into the living body under high pressure.

The magnets 450, 450′ may be a permanent magnet or an electromagnet that is powered by an electromagnet generator that may enable control of the frequency and amplitude of the magnetic field. The magnets may be porous magnets to allow for the flow of gas, such as ozone, therethrough.

Note that the ozone introducer(s) 431 is configured on a first side of the treatment condition 425, or shoulder joint and the magnet 450′ of the second magnetic ozone interface 490′ is configured on the other side or second side of the treatment condition or shoulder joint, to enable the implanted ozone, the internal ozone 436 to pass through the treatment condition. Also, note that the second magnetic ozone interface 490′ is coupled with a pressure apparatus 470 to produce a vacuum of 1 bar on the skin surface to further promote flow of gases through the body and across the treatment location.

A pressure wave apparatus 474 may be coupled with an ozone introducer to apply a pressure wave, such as sound waves to the person's body, which may increase blood flow and may aid to force ozone into the body. A pressure wave controller 182 may be used to control the frequency and pressure applied.

As shown in FIG. 24, a heated sauna 460 forms and enclosure 462 for retaining ozone 430 against a body part. The interior 462 of the sauna is heated by a heating element 466. A head opening 64 in the enclosure enables the patient 421 (living body) to extend their head out of the enclosure. Ozone 430 is configured in the interior of the enclosure and a magnet 450 may be placed against the person's skin to draw ozone into the person's body and across a treatment condition. An ozone generator 438 is the ozone source 432 for providing a flow of ozone 430 into the interior 463 of the enclosure 462. Ozone may be introduced with steam or heated water vapor and the interior of the chamber may be pressurized to increase absorption of ozone. Steam may be initially introduced with the ozone but may cooled to avoid burning due to excessive heat. The steam and or ozone may flow through a conduit 481, and this conduit may include terahertz material 410, such as a coating or layer exposed on the interior of the conduit. Also, a portion of the sauna, such as an interior portion such as the interior walls and/or seat may include terahertz material 410′.

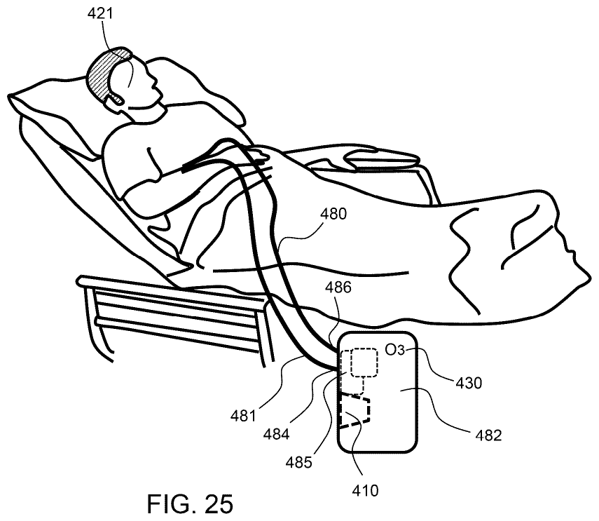

As shown in FIG. 25, a patient 421 is having blood drawn and treated by an ozonating blood apparatus 482 to add ozone 430 to the blood 480 and produce ozonated blood 480 that may be then returned to the patient. As described herein, this may be used to treat any blood born viruses or infections and may be used to treat autoimmune diseases. The ozonating blood apparatus 482 has an inlet 484 for receiving the blood 480 and an ozonated blood outlet 486 to deliver the ozonated blood 80 back to the patient. A pump 485 may control the flow of blood from and/or to the person. The ozonating blood apparatus 482 may include a terahertz material 410 that is configured to impart terahertz frequency to ozone that is introduced into the body and/or to the blood 480 as it is treated.

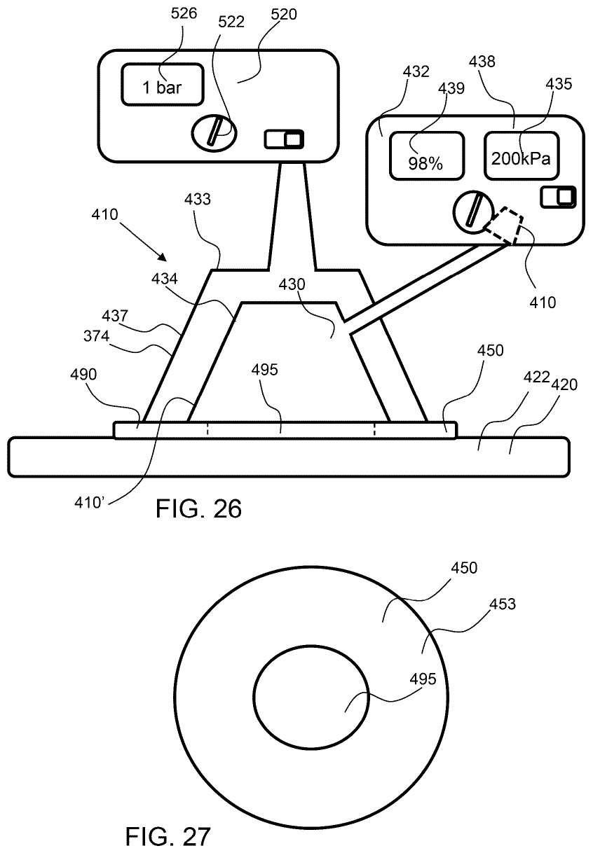

Referring now to FIGS. 26 to 28, an exemplary magnetic ozone interface 490 has a ring magnet 453 coupled to an ozone cup assembly 433 having an internal ozone cup 434 surrounded by a collection cup 437. The magnetic ozone interface 490 may include a terahertz material 410′ that is configured to impart terahertz frequency to ozone. The internal ozone cup 434 receives ozone 430 from an ozone source 432 that may force ozone into the interior of the ozone cup 434 with pressure, as indicated by the pressure gauge 435. The ozone source may be an ozone generator 438 and may produce pure ozone with a concentration as shown in the concentration gauge 439. The collection cup 437 is configured around the ozone cup and configured to capture an ozone that leaks from the interior ozone cup 434. The collection cup is coupled with an ozone destruction device 520 that may create a vacuum pressure as indicated by the pressure gauge 526 and controlled by the pressure regulator 522. The magnet 450 may be a ring magnet 453 with a center aperture 495 to allow the ozone to pass into or out of the body 420, or through the skin 422. The ozone cup assembly 433 may be attached to the magnet 450 to prevent leakage of ozone between the ozone cup assembly and magnet. The magnet may be a switchable magnet configured to turn on and off.

A collection cup 437 may include an ozone destruction material 374, that is configured to destroy the ozone, such as by reaction on a catalyst. Manganese dioxide is an ozone catalyst.

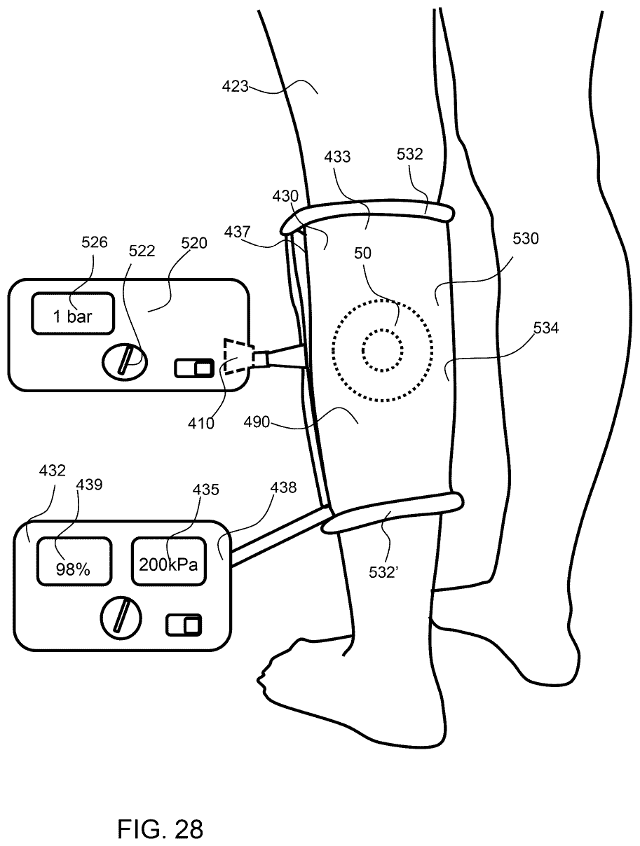

As shown in FIG. 28, an exemplary magnetic ozone interface 490 is wrapped around a person's limb 423, their leg, and comprising an internal ozone cup 434 and collection cup 437 configured around the collection cup, and a magnet 450 configured over a treatment location. The magnetic ozone interface 490 may include a terahertz material 410 that is configured to impart terahertz frequency to ozone. Again, the magnet may be a switchable magnet configured to turn on and off. As described herein, an exemplary magnetic ozone interface may be configured to wrap around a body part including over the shoulder, head, around the back or hip of a person or animal and the like. The ozone cup assembly 433 shown in FIG. 26, may be incorporated with a compression device 530, such as a DVT device that produces pressure around the limb, or compresses the limb. The compression device may include a bladder 534 that is inflated to produce compression around the limb 423 and may include cuffs 532, 532′, which may be inflated or otherwise sinched to prevent ozone 430 from escaping from the bladder 534. The pressure may be pulsed to increase blood flow to the limb.

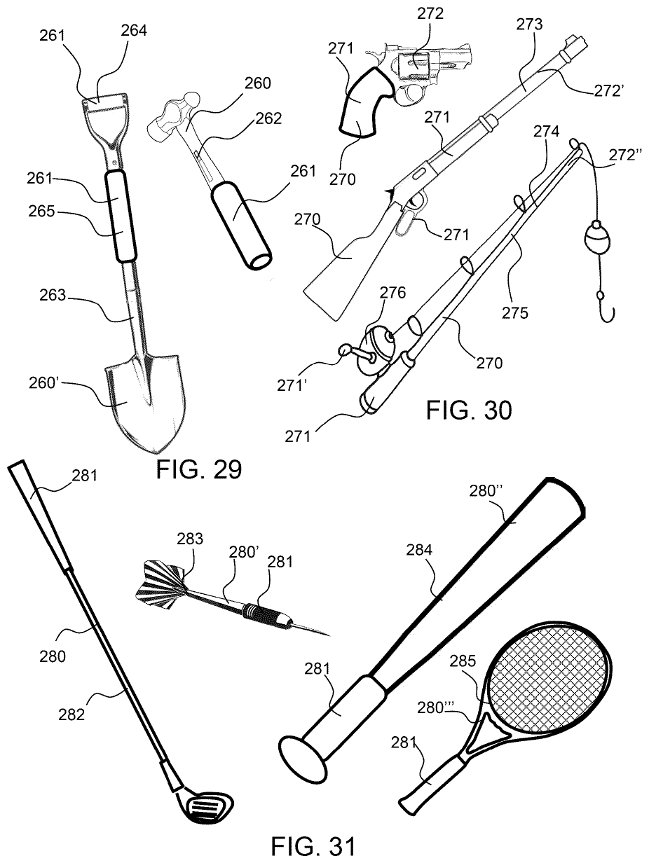

Referring to FIGS. 29 to 31, the terahertz material may be configured in or on the handle of the hand implement, wherein the terahertz material is embedded in the handle material or coated onto the handle.

As shown in FIG. 29, hand implements include hand tools 260, 260′, such as a hammer 262 and shovel 263, that are configured with terahertz material 261 configured on the handle or handles. As described herein, the terahertz material may provide enhanced power and stamina for the person using the hand tool. As shown, the shovel may have the terahertz material on two locations, the handle on the handle end 264 and the handle on the shaft 265 of the shovel.

As shown in FIG. 30, hand implements, outdoor sporting equipment 270, 270′, 270″ such as a handgun 272, a rifle 273 and fishing rod 274, respectively each have terahertz material 271 configured on the handle or handles. The handgun 272 has a single handle and the rifle has two handles, as it is held with two hands. The fighting rod has terahertz material 271 on the handle of the rod 275 and the handle 271′ on the reel 276.

As shown in FIG. 31, hand implements, competitive sporting equipment 280, 280′, 280″, 280′″, such as a golf club 282, a dart 283, a bat 284, a racquet 285, respectively have terahertz material 281 configured on the handle.

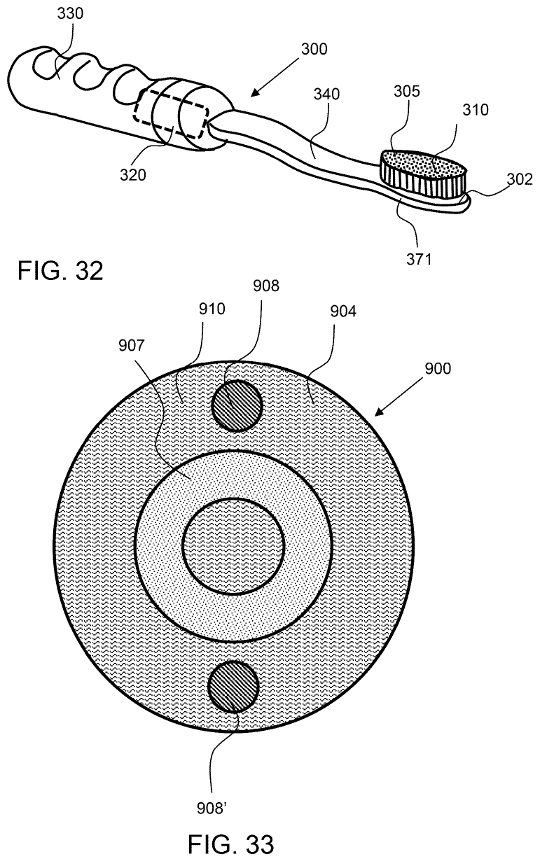

FIG. 32 shows a toothbrush 300 with a toothbrush head 302 that includes a bristles 305 for brushing teeth, and terahertz material 371. The toothbrush head may be a massage implement 310 comprising a terahertz material that emits radiation between 0.1-10 THz (3 mm to 30 μm), between microwave and far infrared spectral region. Also, the toothbrush 300 may include a vibration device 320 that may be configured in the handle 330 and vibrate the toothbrush head 302 and may also vibrate the toothbrush handle extension 340, extending from the handle to the toothbrush head 302. The toothbrush head may vibrate at the frequencies as described herein.

As shown in FIG. 33, a stimulation article 900, such as a disc, include terahertz material 910, magnets 908, 908′, a copper element 907, such as a copper ring or disc. The stimulation article 900 may include the magnets on opposing sides of the copper element as shown and the terahertz material 910 may extend on the skin contact surface 904 and or on the opposing surface. The copper element may be a copper disc, a planar piece of copper with a circular outer perimeter and may be copper disc ring, having a circular aperture centrally configured in the copper disc. The magnets may have the same or opposite poles (north or south) facing out from the skin contact surface. The stimulation device may create magnetic and electrical fields that are amplified by the terahertz material to provide pain relief and/or to relax muscles, tendons, relieve headaches and the like.

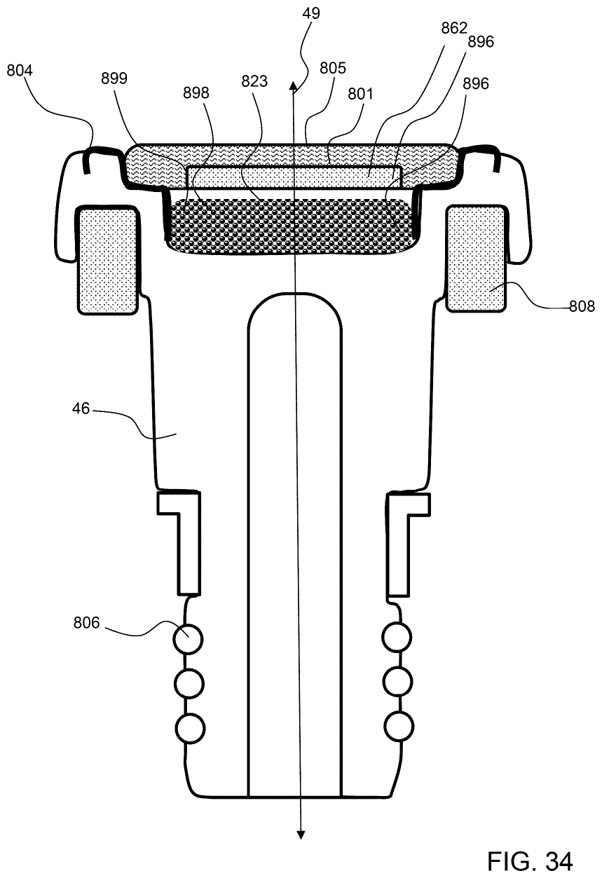

As shown in FIG. 34, a vibrating head shank 46 includes magnetic particles 899 configured in a magnetic sheath 896 to enable the magnetic particles to move as the vibrating head shank is actuated along the vibration axis 49. Therefore, the magnetic particles 899 are a dead-blow component 823, a dynamic magnet 898 that moves when the vibrating head shank moves. Also, a terahertz component 801, such as a disc of a terahertz material, is configured on the vibrating head surface 805. A fixed magnets 808 may be configured on the vibrating head shank 46, and as shown may be a ring magnet that extends around the vibrating head shank 46. As shown, a magnetic connection component 804 extends along the vibrating head surface 805 and down into the magnetic sheath 896 to contact the magnetic particles 899 or dynamic magnet, and may be a copper foil, such as a copper electroplated layer or a thin planar layer of metal. This magnetic connection component electrically couples the vibrating head to the shank at a location offset from the vibrating head. Also, the head component may be wrapped with a magnetic connection component, such as a copper foil. The vibrating head shank 46 may comprise a magnetic shank component 806, such as a copper wire configured around the shank, such as wrapped around the vibrating head shank, as shown. Also, the vibrating head shank may have a gasket or interference fit component to aid in retaining the vibrating head shank to the massage implement 145, as shown in FIG. 2. Note that the massage implement is not shown in FIG. 34 for ease of illustration.

As shown in FIG. 34, the vibrating head 42 may include a heater component that may be heated via electrical resistance heating. Also, a ferromagnetic component may be heated through induction heating by being exposed to the alternating magnetic field. A ferromagnetic component 862 may be configured on the massage head and proximal to a dynamic magnet that induces an alternating magnetic field.

It will be apparent to those skilled in the art that various modifications, combinations and variations can be made in the present invention without departing from the scope of the invention. Specific embodiments, features and elements described herein may be modified, and/or combined in any suitable manner. Thus, it is intended that the present invention cover the modifications, combinations and variations of this invention provided they come within the scope of the appended claims and their equivalents.

What is claimed is:

1. A massage device comprising:
a) a massage implement comprising a terahertz material that emits radiation between 0.1-10 THz (3 mm to 30 μm), between microwave and far infrared spectral region;
wherein the massage implement comprises a vibrating portion that vibrates and wherein the terahertz material is configured on said vibrating portion of the massage implement;
wherein massage implement is a massage gun comprising:
b) a massage device body;
c) a vibrating head shank; and
d) a vibrating head coupled to the massage device body by the vibrating head shank; and
wherein the vibrating head shank moves back and forth with respect to the massage device body;
e) a magnet and wherein the magnet is a dynamic magnet and moves with respect to the vibrating head shank;
wherein the dynamic magnet is configured within a magnet sheath; and
wherein the magnet sheath forms a portion of the vibrating head shank.

2. The massage device of claim 1, wherein the terahertz material is configured on said vibrating head.

3. The massage device of claim 1, wherein the dynamic magnet is a permanent magnet.

4. The massage device of claim 1, wherein the dynamic magnet is an electromagnet.

5. The massage device of claim 1, wherein terahertz material is configured on the vibrating head surface.

6. The massage device of claim 1, further comprising a magnet stop configured within the magnet sheath to limit a range of motion of the dynamic magnet within the magnet sheath.

7. The massage device of claim 1, wherein the magnet sheath is electrically conductive.

8. The massage device of claim 1, wherein the massage device further comprises a fixed magnet configured on the massage device body that is stationary with respect to the vibrating head; and
wherein movement of the dynamic magnet with respect to the fixed magnet produces a variable magnetic field.

9. The massage device of claim 8, wherein the dynamic magnet is a ring magnet configured around the vibrating head shank.

10. The massage device of claim 8, wherein the fixed magnet is a ring magnet configured around the vibrating head shank.

11. The massage device of claim 8, wherein the dynamic magnet and fixed magnet have aligned magnetic poles with respect to a vibration axis whereby the dynamic magnet is attracted to the fixed magnet.

12. The massage device of claim 8, wherein the dynamic magnet and fixed magnet have opposing magnetic pole orientations with respect to a vibration axis, whereby the dynamic magnet is magnetically repelled from the fixed magnet.

13. The massage device of claim 1, further comprising a magnetic component configured on the vibrating head of said massage device.

14. The massage device of claim 13, wherein the magnetic component is a magnetic metal.

15. The massage device of claim 13, wherein the magnetic component is configured on a vibrating head surface of the vibrating head.

16. The massage device of claim 15, further comprising a magnetic connection component that extends from the dynamic magnet to the vibrating head surface.

17. The massage device of claim 1, wherein the massage device comprises a vibrator implement that produces a vibration of the vibrating portion.

18. The massage device of claim 1, further comprising a dead-blow component forming an enclosure for dead-blow particles and wherein the dead-blow component is configured on the vibrating head shank to transfer kinetic energy to the vibrating head.

19. The massage device of claim 18, wherein the dead-blow particles comprise metal particles.

20. The massage device of claim 18, wherein the dead-blow particles comprise terahertz material.

21. The massage device of claim 20, wherein the dead-blow particles comprise magnetic particles and wherein the dynamic magnet comprises said magnetic particles.
